(19) United States
(12) Patent Application Publication
(10) Pub. No.: US 2024/0031527 A1
(43) Pub. Date: Jan. 25, 2024

(54) APPARATUS, SYSTEMS, AND METHODS FOR VIDEOCONFERENCING DEVICES

(71) Applicant: Meta Platforms Technologies, LLC, Menlo Park, CA (US)

(72) Inventor: Colleen Kelly Henry, Oakland, CA (US)

(21) Appl. No.: 17/868,823

(22) Filed: Jul. 20, 2022

(51) Int. Cl. H04N 7/14; H04R 1/40

(52) U.S. Cl. CPC H04N 7/142; H04R 1/406

(57) ABSTRACT

An apparatus for a videoconferencing device may include (i) at least one directional sensor that detects a direction of a user relative to the videoconferencing device, (ii) a physical camera that records video data of a location, (iii) a virtual camera that records a subset of the video data such that a camera frame of the virtual camera follows the user as the user moves within the location, (iv) a directional set of audio transducers that projects audio in a single direction over a limited portion of the location, and (v) a computing module that configures the directional set of audio transducers to project the audio in the direction of the user. Various other methods, systems, and computer-readable media are also disclosed.

### BRIEF DESCRIPTION OF THE DRAWINGS

The accompanying drawings illustrate a number of exemplary embodiments and are a part of the specification. Together with the following description, these drawings demonstrate and explain various principles of the instant disclosure.

FIG. 1 is a block diagram of an exemplary system for videoconferencing.

FIG. 2 is a flow diagram of an exemplary method for videoconferencing.

FIG. 3 is an illustration of an exemplary purpose-built videoconferencing device.

FIG. 4 is an illustration of an exemplary multi-component videoconferencing system.

FIG. 5 is an illustration of an exemplary videoconferencing device in context.

FIGS. 6A-6C are illustrations of exemplary sets of audio transducers.

FIG. 7 is an illustration of exemplary directional sensors for a videoconferencing device.

FIGS. 8A and 8B are illustrations of an exemplary videoconferencing device with dynamically adjusted volume.

Throughout the drawings, identical reference characters and descriptions indicate similar, but not necessarily identical, elements. While the exemplary embodiments described herein are susceptible to various modifications and alternative forms, specific embodiments have been shown by way of example in the drawings and will be described in detail herein. However, the exemplary embodiments described herein are not intended to be limited to the particular forms disclosed. Rather, the instant disclosure covers all modifications, equivalents, and alternatives falling within the scope of the appended claims.

Features from any of the embodiments described herein may be used in combination with one another in accordance with the general principles described herein. These and other embodiments, features, and advantages will be more fully understood upon reading the following detailed description in conjunction with the accompanying drawings and claims.

### DETAILED DESCRIPTION OF EXEMPLARY EMBODIMENTS

Current videoconferencing systems are typically equipped with omnidirectional speakers that project audio broadly throughout the space in which the videoconference system is located. This may be disruptive to other users in the space, such as the other occupants of a home, office, or co-working space. Directional speakers may solve part of this problem; however, they may require the user to remain in a specified position to receive the audio projected by the speakers, preventing the user from moving around their home or office for comfort or to perform tasks while on the call. To solve both problems, the disclosed videoconferencing device includes a computing module that configures a set of audio transducers to direct audio in a manner that follows a user as they move in conjunction with a virtual camera that also follows the user. This enables a user to move around a space while on a video call with clear audio and video without disrupting other users in the vicinity.

In some embodiments, the videoconferencing device may include a focused directional microphone that also follows the user in order to improve the quality of audio input. Additionally or alternatively, the videoconferencing device may detect the distance between the user and the device and adjust the volume of audio output, raising the volume when the user is farther away and lowering the volume when the user is closer. The disclosed system may enhance the usability of videoconferencing devices and enable users to carry out high-quality audio and/or video conversations while moving around.

In some embodiments, the systems described herein may improve the functioning of a computing device by improving the quality of audio input and/or output during a videoconferencing and/or audio call. Additionally, the systems described herein may improve the field of videoconferencing by facilitating a high-quality video call experience that enables a user to move around a space but does not disturb other nearby users with excess sound.

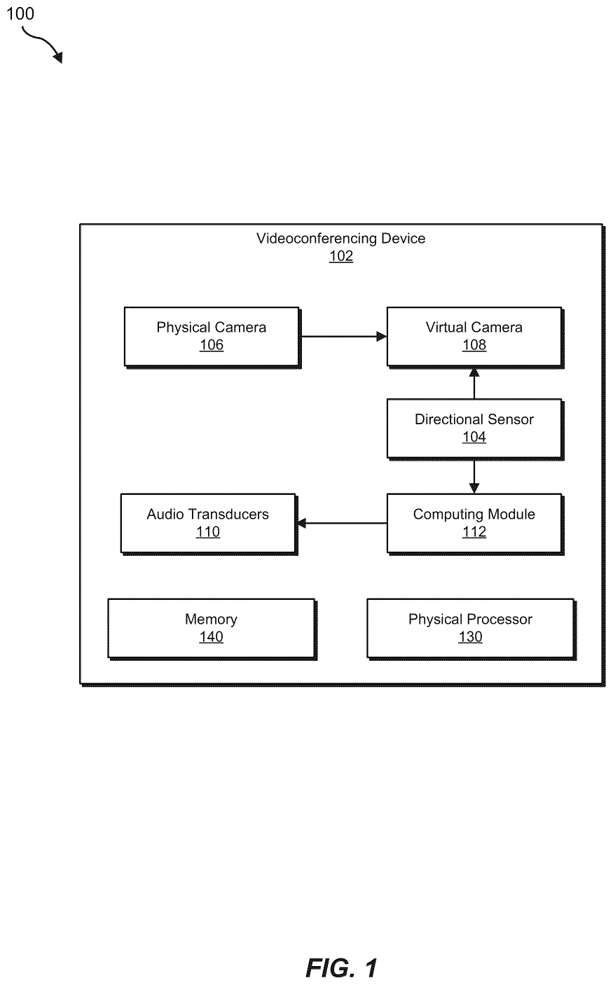

FIG. 1 is a block diagram of an exemplary system 100 for videoconferencing. In one embodiment, and as will be described in greater detail below, a videoconferencing device 102 may be configured with at least one directional sensor 104 that detects a direction of a user relative to videoconferencing device 102. Videoconferencing device 102 may also be configured with a physical camera 106 that records video data of a location and a virtual camera 108 that records a subset of the video data. Additionally, videoconferencing device 102 may be configured with a directional set of audio transducers 110 that projects audio in a single direction over a limited portion of the location and a computing module 112 that configures directional set of audio transducers 110 to project the audio in the direction of the user.

Videoconferencing device 102 generally represents any type or form of computing device capable of facilitating a videoconference (i.e., a communication between two or more users that includes audio and/or video). For example, videoconferencing device 102 may represent a purpose-built videoconferencing device that is primarily designed to facilitate videoconferences rather than for general-purpose computing. In some embodiments, videoconferencing device may include disparate physical components that are connected by wires and/or wirelessly. For example, directional sensor 104, physical camera 106, and/or a display surface of videoconferencing device 102 may be physically separate rather than contained in the same housing. In one example, directional sensor 104 may be a device worn by the user, physical camera 106 may be mounted on the wall of a room and a display surface may be mounted separately on the wall of the room. Additionally or alternatively, videoconferencing device 102 may be a general-purpose computing device. Additional examples of videoconferencing device 102 may include, without limitation, a laptop, a desktop, a wearable device, a smart device, an artificial reality device, a personal digital assistant (PDA), etc.

Directional sensor 104 generally represents any type or form of sensor capable of detecting the location, direction, and/or distance of a user relative to the videoconferencing device. In some embodiments, directional sensor 104 may perform functions in addition to sensing direction. For example, physical camera 106 may serve as directional sensor 104 by detecting the location of the user based on visual data in addition to capturing video of the user for display within the video conference. In some embodiments, directional sensor 104 may be an additional device or physical component that is not physically part of the main housing of videoconferencing device 102. For example, a cell phone in the user's pocket may provide location or direction data to videoconferencing device 102. Additional examples of directional sensor 104 include, without limitation, infrared sensors, radio frequency transceivers, capacitive sensors, visual sensors of any type, microphones, audio receivers of any type, worn and/or carried devices (e.g., smart watches, fitness trackers, etc.), and/or pressure sensors.

Physical camera 106 generally represents any type or form of hardware sensor that captures live visual data. In one embodiment, physical camera 106 may be a digital video camera that receives light and converts the received light into electronic data. In some embodiments, physical camera 106 may store visual data as a series of image frames in any of a variety of file formats. In one embodiment, physical camera 106 may be fixed in a specific position (e.g., as opposed to capable of moving and/or rotating). In some embodiments, physical camera 106 may be an embedded camera in videoconferencing device 102 (e.g., a webcam). Additionally or alternatively, physical camera 106 may be an external camera connected to videoconferencing device 102.

Virtual camera 108 generally represents any type or form of software capable of capturing a subset of the visual data captured by a physical camera. For example, if a physical camera captures an entire room, a virtual camera may capture just the portion of the room in which a user is standing. In one embodiment, a virtual camera may identify a physical camera frame (e.g., an image that is 3,264 by 2,448 pixels) and select a subset of the frame (e.g., a rectangular area that is 800 by 600 pixels, starting at the very top left corner of the physical camera frame) to be the virtual camera frame. In the next frame, the virtual camera frame may move (e.g., capturing an 800 by 600 pixel area that is offset from the top left of the physical camera frame by two pixels in each direction) relative to the boundaries of the physical camera frame, creating a video stream that captures different areas of a physical space even though the physical camera does not move. A virtual camera frame may be any size that is equal to or smaller than the physical camera frame, any shape that fits within the physical camera frame (e.g., a rectangular virtual camera frame within a larger square physical camera frame), and/or located anywhere within the physical camera frame. In some embodiments, virtual camera 108 may track a user and/or a user's face (e.g., using face-tracking and/or motion-tracking algorithms) to ensure that the user is within the camera frame of virtual camera 108 whenever possible (e.g., whenever the user is within the visual range of physical camera 106).

Audio transducers 110 generally represent any set of hardware components that transform electronic signals into audio output (e.g., acoustic waves). In some embodiments, audio transducers 110 may be directional transducers that generate ultrasound waves (i.e., high frequency sound waves) in a focused beam (as opposed to a cone or a sphere generated by omnidirectional transducers). For example, audio transducers 110 may include an array of piezoelectric transducers. Piezoelectric transducers may be formed from a variety of materials, such as quartz crystals, that vibrate when exposed to an electric current. Additionally or alternatively, audio transducers 110 may include electrodynamic transducers and/or electrostatic transducers.

An array of directional transducers may direct sound to a user in a variety of ways. For example, the array may be configured to emit a focused beam of ultrasonic waves that form an interference pattern that produces human-audible sound upon striking a surface. The array of directional transducers may emit a carrier frequency and a modulation frequency in parallel with each other. In some embodiments, both the carrier frequency and the modulation frequency may reside in the ultrasonic portion of the sound spectrum, such as 200 kHz for the carrier frequency and between 200.2 kHz and 220 kHz for the modulation frequency. These beams may, upon contact with a surface such as a human head, interfere to produce an interference wave with a frequency between 200 and 20,000 Hz (the approximate range of human hearing). An array of transducers that operates in the above-described manner may be referred to as a “parametric loudspeaker.”

In some embodiments, audio transducers 110 may direct sound to a limited portion of a location. For example, audio transducers 110 may direct audio in a beam across a limited, cylindrical portion of a location such that the audio only becomes audible when encountering an object (e.g., a user). In one example, a limited portion of a location may include the area where a user is standing but not the parts of a room where other people are standing, an open door to another room, and/or other locations where stray audio would potentially distract other people.

Computing module 112 generally represents any hardware, firmware, and/or software capable of reading computer-executable instructions. In some embodiments, computing module 112 may execute various computing processes and/or applications that facilitate videoconferencing. In some embodiments, computing module 112 may send instructions to other software and/or hardware components of videoconferencing device 102, such as audio transducers 110. In one embodiment, computing module 112 may execute virtual camera 108.

As illustrated in FIG. 1, example system 100 may also include one or more memory devices, such as memory 140. Memory 140 generally represents any type or form of volatile or non-volatile storage device or medium capable of storing data and/or computer-readable instructions. In one example, memory 140 may store, load, and/or maintain one or more of the modules illustrated in FIG. 1. Examples of memory 140 include, without limitation, Random Access Memory (RAM), Read Only Memory (ROM), flash memory, Hard Disk Drives (HDDs), Solid-State Drives (SSDs), optical disk drives, caches, variations or combinations of one or more of the same, and/or any other suitable storage memory.

As illustrated in FIG. 1, example system 100 may also include one or more physical processors, such as physical processor 130. Physical processor 130 generally represents any type or form of hardware-implemented processing unit capable of interpreting and/or executing computer-readable instructions. In one example, physical processor 130 may access and/or modify one or more of the modules stored in memory 140. Additionally or alternatively, physical processor 130 may execute one or more of the modules. Examples of physical processor 130 include, without limitation, microprocessors, microcontrollers, Central Processing Units (CPUs), Field-Programmable Gate Arrays (FPGAs) that implement softcore processors, Application-Specific Integrated Circuits (ASICs), portions of one or more of the same, variations or combinations of one or more of the same, and/or any other suitable physical processor.

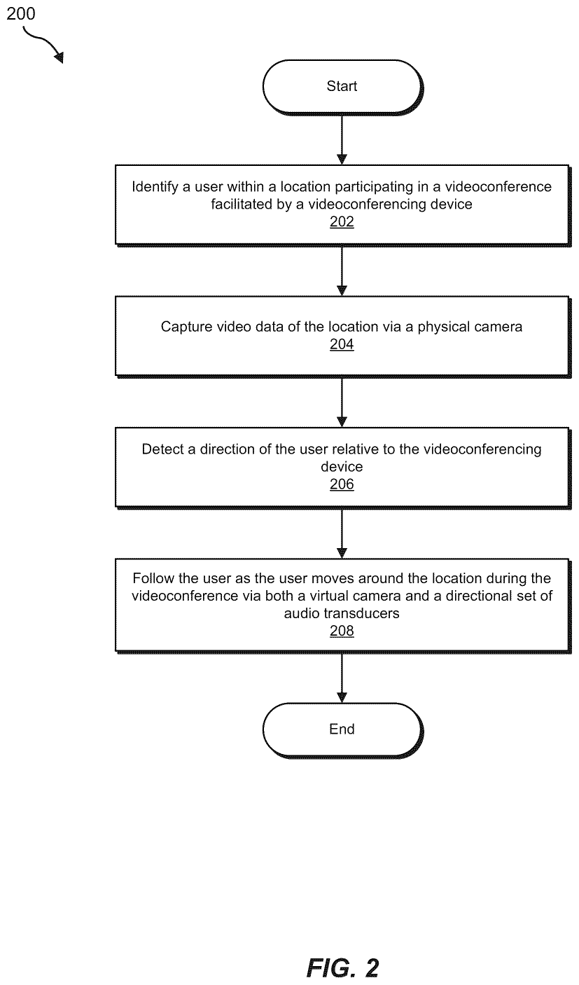

FIG. 2 is a flow diagram of an exemplary method 200 for videoconferencing. In some examples, at step 202, the systems described herein may identify a user within a location participating in a videoconference facilitated by a videoconferencing device. For example, the systems described herein may identify a user in an office participating in a video meeting. In one example, the user may be the only person in the office. In other examples, multiple people may be in the office and the systems may identify the user and may follow that user specifically via facial recognition techniques.

At step 204, the systems described herein may capture video data of the location via a physical camera. In one embodiment, the systems described herein may capture video data of the location via a single physical camera. In other embodiments, the systems described herein may capture video data of the location via multiple physical cameras and the virtual camera may switch between physical camera views periodically (e.g., in response to the user turning and/or moving).

At step 206, the systems described herein may detect a direction of the user relative to the videoconferencing device. In some embodiments, the systems described herein may monitor the direction of the user continuously. Alternatively, the systems described herein may check the direction of the user at regular intervals (e.g., every second, every five seconds, etc.) and/or in response to a trigger (e.g., when movement is detected).

The systems described herein may detect the direction of the user in a variety of ways. For example, the systems described herein may detect the direction of the user via a visual sensor, such as a physical camera (e.g., the same camera recording the user for the videoconference) that identifies the location of the user within the camera frame and thus the direction of the user relative to the videoconferencing device. In another example, a device worn or carried by the user (e.g., a smartphone, tablet, smartwatch, fitness tracker, a purpose-built location tracker, etc.) may send the user's location to the videoconferencing device using any of a variety of technologies (e.g., wi-fi, near-field communication, radio frequency, etc.), enabling the videoconferencing device to determine the relative direction of the user. In one embodiment, the systems described herein may use a light-detecting sensor other than a typical video camera, such as an infrared sensor and/or a light detecting and ranging (LIDAR) sensor, to determine the direction of the user relative to the videoconferencing device. For example, the systems described in may send out a LIDAR pulse in multiple directions and, based on the time it takes the reflected light to arrive from the pulse compared to the time it takes in an empty room, determine the position and thus relative direction of the user.

Additionally or alternatively, the systems described herein may use touch-based sensor such as capacitive sensors and/or pressure sensors. In one embodiment, an array of small pressure sensors on the floor of a room (e.g., one under each tile of a tiled floor, affixed in a grid to the underside of a carpet, etc.) may determine the location of a user within the room based on which sensor is activated (e.g., receiving pressure due to the user standing on the sensor). Similarly, capacitive sensors on flooring or other objects (e.g., furniture, devices, etc.) may send activation data to the videoconferencing system. In some embodiments, the systems described herein may determine a user's relative direction based on audio receivers. For example, an array of microphones (that capture audio for the videoconference and/or serve other purposes) may determine the location of the user based on the different volume of audio received by microphones in different locations and/or facing different directions.

At step 208, the systems described herein may follow the user as the user moves around the location during the videoconference via both a virtual camera and a directional set of audio transducers. In some embodiments, the systems described herein may also follow the user via a focused directional microphone. In one embodiment, a focused directional microphone may be a directional microphone that receives audio input from a single direction as opposed to an omnidirectional microphone that receives audio input from every direction or a standard directional microphone that receives audio from a limited directional area that is broader than a single direction. In some embodiments, the systems described herein may configure a focused directional microphone (e.g., via software and/or hardware) to modify the direction in which the focused directional microphone captures audio such that that direction is the direction of the user relative to the microphone.

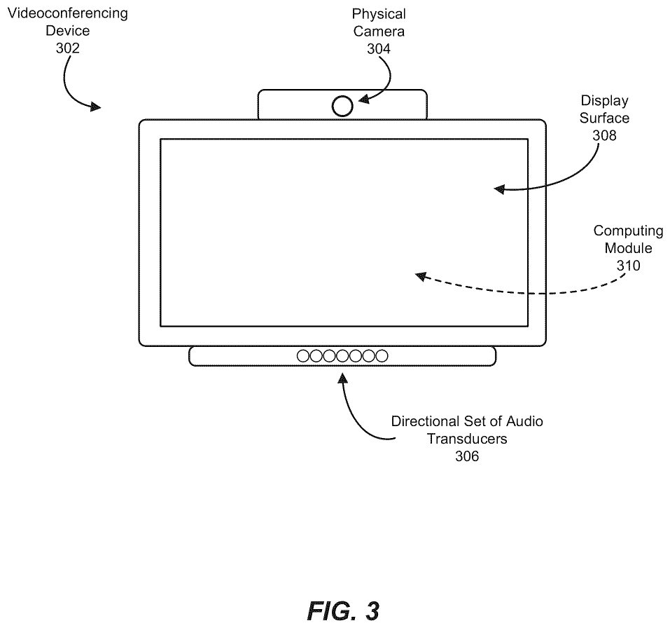

In some embodiments, a videoconferencing system may be a discrete device with all of the systems described herein contained within a single housing. For example, as illustrated in FIG. 3, a videoconferencing device 302 may include a physical camera 304, directional set of audio transducers 306, a display surface 308, and a computing module 310 (not visible). In one example, physical camera 304 may act as a directional sensor and/or computing module 310 may execute a virtual camera. In one embodiment, videoconferencing device 302 may be a purpose-built device designed to facilitate videoconferencing.

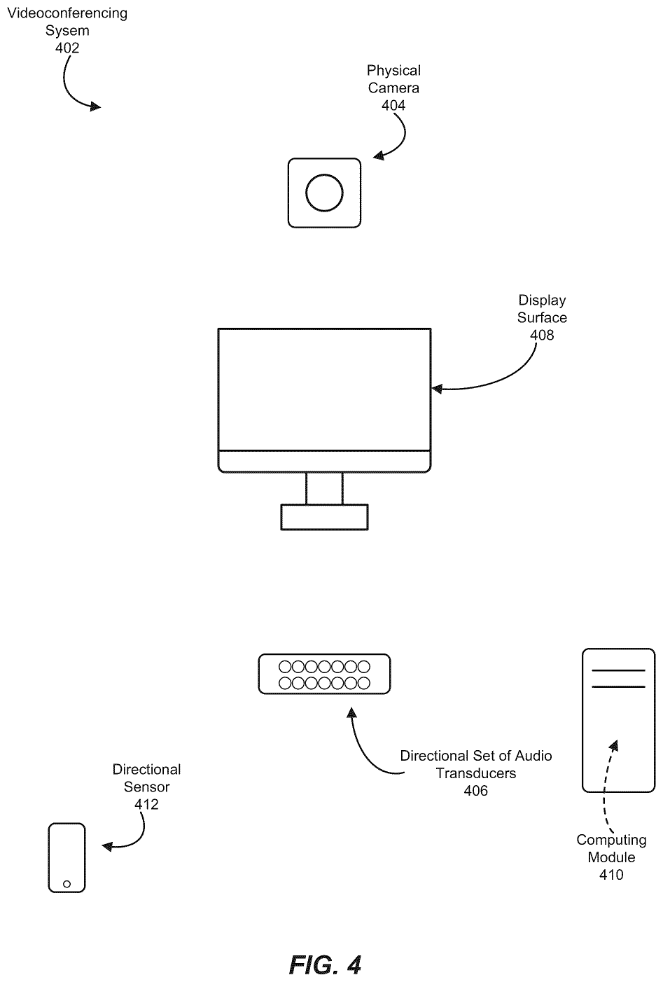

Additionally or alternatively, a videoconferencing system may be composed of multiple physical components connected with wires and/or wirelessly. For example, as illustrated in FIG. 4, a videoconferencing system 402 may include a physical camera 404 in its own discrete housing. In one example, physical camera 404 may be a dedicated camera peripheral. In some examples, videoconferencing system 402 may include a display surface 408 that displays video for the videoconference. In one example, display surface 408 may be an off-the-shelf general-purpose computing device such as a laptop, tablet, monitor, or smart television. Videoconferencing system 402 may include a directional set of audio transducers 406 that provides audio output and/or input for the videoconference as well as a computing module 410 that provides instructions to audio transducers 406. In some embodiments, computing module 410 may include software executing on a general-purpose computing device such as a tower, a laptop, etc. In one embodiment, a directional sensor 412 may be a physically discrete device such as a device worn or carried by a user, a pressure sensor, an infrared sensor peripheral, etc.

Although illustrated as one extreme (all components in a single housing) or another (all components in separate housings), the hardware and software components of a videoconferencing system may be configured, coupled, and/or housed in various ways. For example, a single housing may include the display surface, physical camera that acts as a directional sensor, and computing module while a separate housing contains the audio transducers. In another example, a single housing may include the display surface, computing module, and audio transducers while the physical camera may be a separate device.

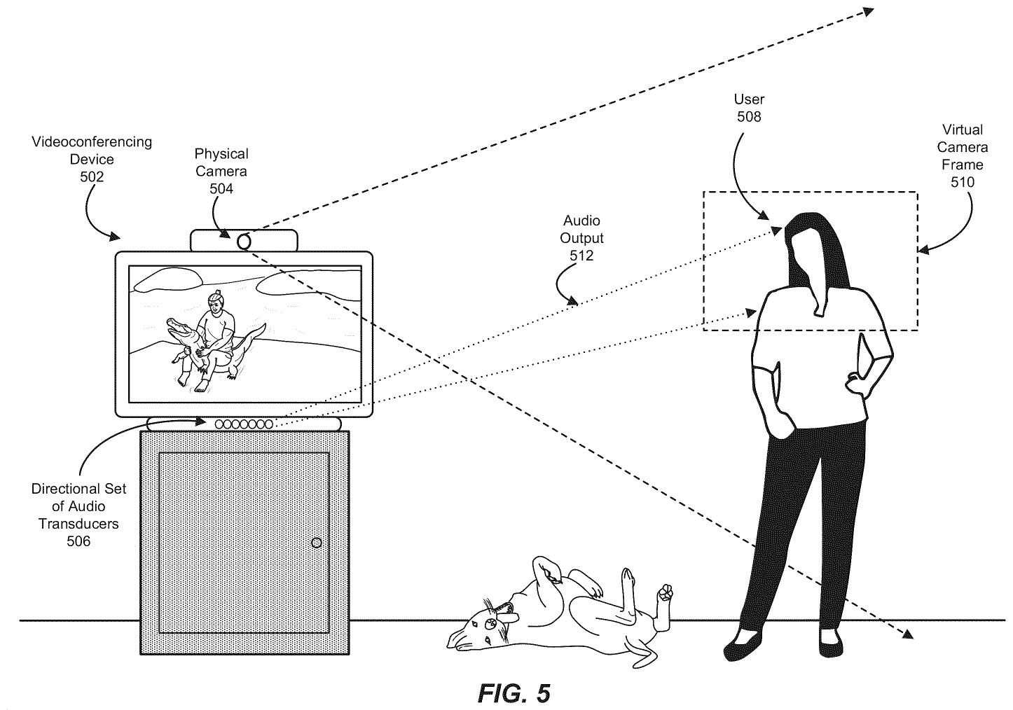

In some embodiments, the systems described herein may enable a user to have a high-quality video call while moving around a room. For example, as illustrated in FIG. 5, a videoconferencing device 502 may be positioned such that a physical camera 504 is capable of visually capturing most of the room. However, a virtual camera may keep a virtual camera frame 510 centered on the face of a user 508, sending only that portion of the room to a video call. Meanwhile, a directional set of audio transducers 506 may project audio output 512 towards user 508 so that, regardless of where user 508 moves in the room, user 508 can clearly hear the sounds of her friend competing in an alligator wrestling competition on the other end of the video call but these sounds do not disturb other occupants of the house. In some embodiments, a focused directional microphone may also move and/or be reconfigured in response to user 508 moving around the room.

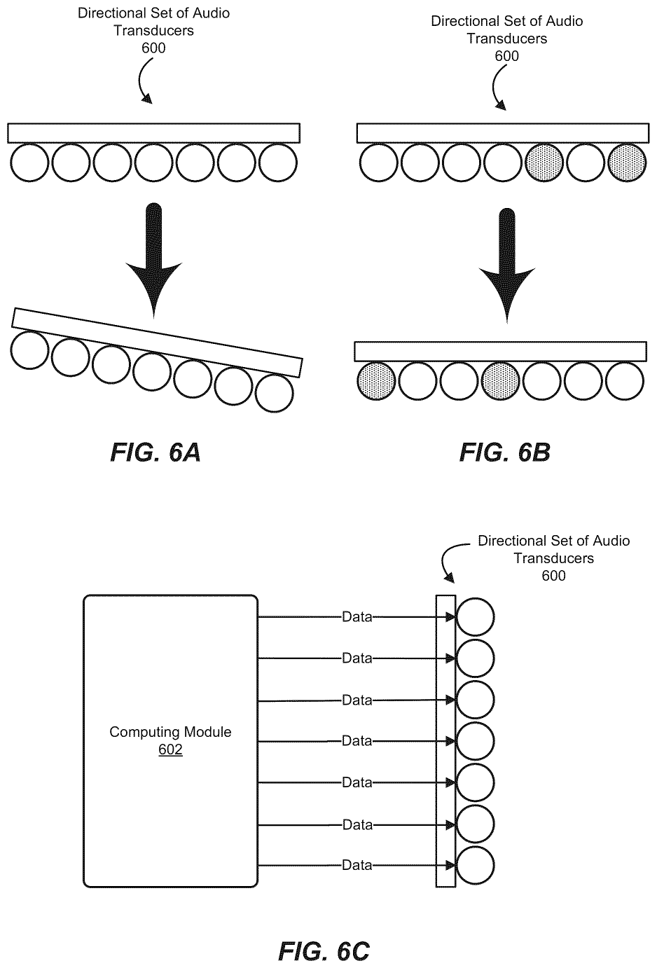

The systems described herein may configure the directional set of audio transducers to follow a user in a variety of different ways, as illustrated in FIGS. 6A-6C. In one example, as illustrated in FIG. 6A, a computing module may reconfigure a directional set of audio transducers 600 by directing a physical motor to move and/or rotate at least a portion of the directional set of audio transducers. For example, a motor may drive a set of gears to rotate a base to which one or more audio transducers are affixed. In some examples, the systems described herein may move and/or rotate the directional set of audio transducers as a group, as shown in FIG. 6A. Additionally or alternatively, the systems described herein may move and/or rotate each transducer as an individual unit. For example, each transducer may be affixed to an individual base that can be rotated independently of other bases and transducers. Moving and/or rotating some or all of the audio transducers may change the direction in which the audio output is projected, enabling the directional audio output to follow the user as the user moves (e.g., via beamforming, as described above in connection with FIG. 1).

In some embodiments, as illustrated in FIG. 6B, a computing module may reconfigure directional set of audio transducers 600 by toggling an activation state of at least a portion of the audio transducers. For example, the computing module may turn some audio transducers off and/or turn other audio transducers on to change the direction in which the audio output is projected. In some embodiments, different audio transducers may face different directions and/or be calibrated to project audio in different directions and activating or deactivating each audio transducer may enable the directional audio output to follow the user as the user moves.

Additionally or alternatively, as illustrated in FIG. 6C, a computing module 602 may send data to each audio transducer within directional set of audio transducers 600. In some examples, computing module 602 may alter the data being sent to some or all of the audio transducers in order to change the direction in which the audio output is projected. For example, computing module 602 may send data that directs the audio transducers to produce output at a delay (e.g., relative to input and/or to other transducers in the set), produce output at varying volumes (e.g., such that some transducers produce louder output than others), and/or produce output at frequencies that causes cancellation effects for other output.

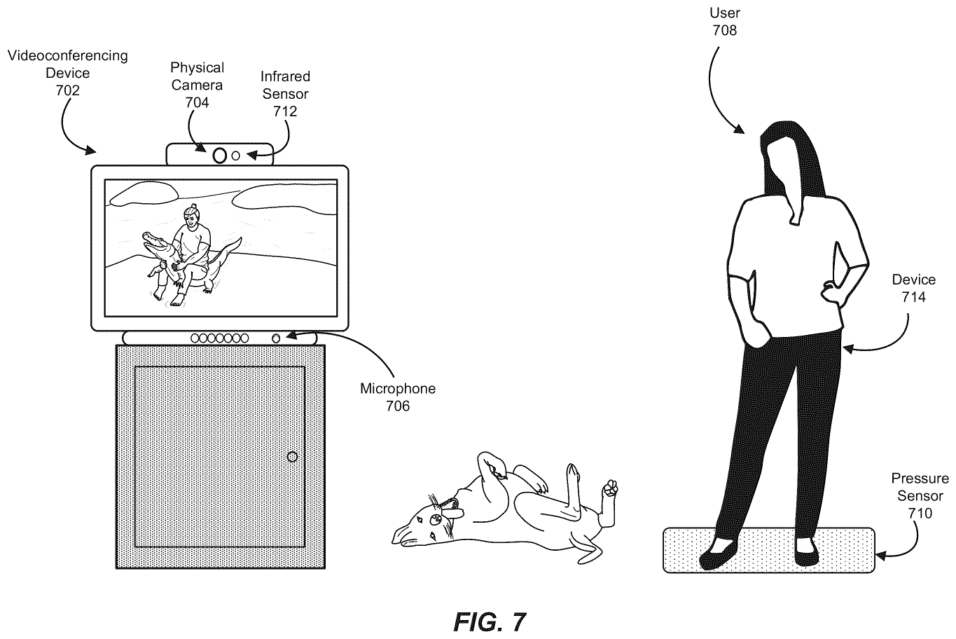

The systems described herein may track the direction of the user relative to the videoconferencing device in a variety of ways. For example, as illustrated in FIG. 7, a videoconferencing device 702 may have a physical camera 704 that captures video for the videoconference. In some embodiments, physical camera 704 may also function as a directional sensor and the systems described herein may determine the direction of a user 708 relative to videoconferencing device 702 based at least in part on data captured by physical camera 704. Additionally or alternatively, videoconferencing device 702 may have an infrared sensor 712 that captures infrared data and functions as a directional sensor. In some embodiments, videoconferencing device 702 may have a microphone 706 that captures audio data for the videoconference. Microphone 706 may represent a single microphone or an array of microphones in one or more locations. In some examples, the systems described herein may use audio data captured by microphone 706 to determine the direction of user 708 relative to videoconferencing device 702. In some examples, user 708 may wear or carry a device 714 (e.g., a phone, smart watch, etc.) that may be equipped with a location sensor of some type. In one embodiment, the systems described herein may determine the direction of user 708 relative to videoconferencing device 702 based at least in part on data received from device 714. In some embodiments, a room with a videoconferencing system may be configured with a variety of pressure sensors in different locations of the room (e.g., attached to the bottom of a carpet, built in to tiled flooring, etc.). In one example, user 708 may stand on a pressure sensor 710 that may send data to videoconferencing device 702 that enables videoconferencing device 702 to determine the location of user 708.

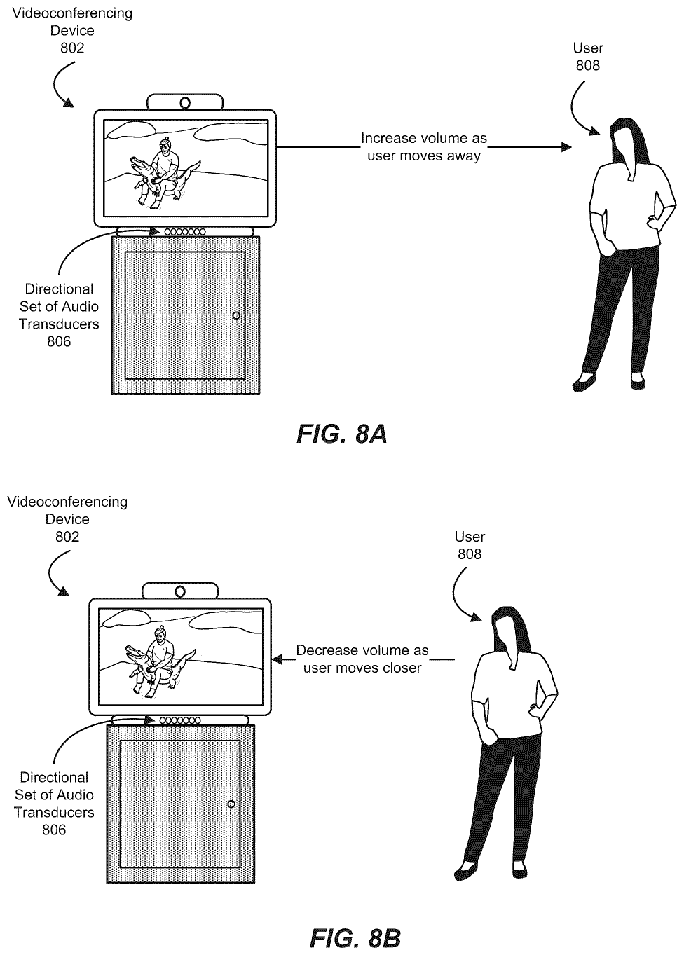

In some embodiments, in addition to following a user with a virtual camera, directional set of audio transducers, and/or focused directional microphone, the systems described herein may alter the volume of audio output produced by a videoconferencing device based on the relative location of the user. For example, as illustrated in FIG. 8A, a videoconferencing device 802 may increase the volume of audio output produced by a directional set of audio transducers 806 in response to a user 808 moving away from videoconferencing device 802. Similarly, as illustrated in FIG. 8B, videoconferencing device 802 may decrease the volume of audio output produced by directional set of audio transducers 806 in response to user 808 moving closer to videoconferencing device 802. The systems described herein may determine the distance of the user relative to the videoconferencing device using any type of location and/or distance sensor, including but not limited to the sensor options described in conjunction with FIG. 7.

As described above, the systems and methods described herein may improve the quality and user experience of a videoconference by following a user with a virtual camera, directional speaker, and/or focused directional microphone as the user moves around a space. By following a user in this manner, the systems described herein may enable a user to draw on a whiteboard, perform household tasks, or simply move around for comfort while maintaining high quality audio and video and without disturbing other users in the vicinity with excessive leaking audio. Facilitating videoconferences in this way may enable users to have higher-quality meetings and conversations with a lower impact on other users within the space, improving the experience of those working from home or in crowded offices or co-working spaces.

### EXAMPLE EMBODIMENTS

Example 1: An apparatus for a videoconferencing device may include (i) at least one directional sensor that detects a direction of a user relative to the videoconferencing device, (ii) a physical camera that records video data of a location, (iii) a virtual camera that records a subset of the video data such that a camera frame of the virtual camera follows the user as the user moves within the location, (iv) a directional set of audio transducers that projects audio in a single direction over a limited portion of the location, and (v) a computing module that configures the directional set of audio transducers to project the audio in the direction of the user.

Example 2: The videoconferencing device of example 1, where the computing module configures the directional set of audio transducers by triggering a physical motor to move at least a portion of the directional set of audio transducers.

Example 3: The videoconferencing device of examples 1-2, where the computing module configures the directional set of audio transducers by altering audio data sent to the directional set of audio transducers.

Example 4: The videoconferencing device of examples 1-3, where the computing module configures the directional set of audio transducers by toggling an active state of a portion of the directional set of audio transducers.

Example 5: The videoconferencing device of examples 1-4, further including a directional microphone that captures audio input from a specific direction over a portion of the location and where the computing module that configures the directional microphone to capture the audio input from the direction of the user.

Example 6: The videoconferencing device of examples 1-5, where the directional sensor includes at least one of a microphone that captures audio of the user or the physical camera.

Example 7: The videoconferencing device of examples 1-6, where the directional sensor includes a device worn by the user that sends location data to the videoconferencing device.

Example 8: The videoconferencing device of examples 1-7, where the directional sensor includes a set of pressure sensors distributed throughout the location.

Example 9: The videoconferencing device of examples 1-8, where the directional sensor includes an infrared sensor.

Example 10: The videoconferencing device of examples 1-9, where the computing module calculates a distance between the user and the directional set of audio transducers and modifies a volume of the audio produced by the directional set of audio transducers based on the distance between the user and the directional set of audio transducers.

Example 11: A computer-implemented method for videoconferencing may include (i) identifying a user within a location participating in a videoconference facilitated by a videoconferencing device, (ii) capturing video data of the location via a physical camera, (iii) detecting a direction of the user relative to the videoconferencing device, and (iv) following the user as the user moves around the location during the videoconference via both (a) a virtual camera that captures a subset of the video data captured by the physical camera such that the user is within a frame of the virtual camera and (b) a directional set of audio transducers that projects audio in a single direction over a limited portion of the location such that the audio is projected in the direction of the user.

Example 12: The computer-implemented method of example 11, where following the user via the directional set of audio transducers includes triggering a physical motor to move at least a portion of the directional set of audio transducers.

Example 13: The computer-implemented method of examples 11-12, where following the user via the directional set of audio transducers includes altering audio data sent to the directional set of audio transducers.

Example 14: The computer-implemented method of examples 11-13, where following the user via the directional set of audio transducers includes toggling an active state of a portion of the directional set of audio transducers.

Example 15: The computer-implemented method of examples 11-14 may further include following the user with a directional microphone that captures audio input from a specific direction over a portion of the location.

Example 16: The computer-implemented method of examples 11-15, where detecting the direction of the user relative to the videoconferencing device includes detecting the direction via at least one of a microphone that captures audio of the user or the physical camera.

Example 17: The computer-implemented method of examples 11-16, where detecting the direction of the user relative to the videoconferencing device includes detecting the direction via at least one of a device worn by the user that sends location data to the videoconferencing device, a set of pressure sensors distributed throughout the location, or an infrared sensor.

Example 18: The computer-implemented method of examples 11-17 may further include calculating a distance between the user and the directional set of audio transducers and modifying a volume of the audio produced by the directional set of audio transducers based on the distance between the user and the directional set of audio transducers.

Example 19: A non-transitory computer-readable medium including one or more computer-executable instructions that, when executed by at least one processor of a computing device, may cause the computing device to (i) identify a user within a location participating in a videoconference facilitated by a videoconferencing device, (ii) capture video data of the location via a physical camera, (iii) detect a direction of the user relative to the videoconferencing device, and (iv) follow the user as the user moves around the location during the videoconference via both (a) a virtual camera that captures a subset of the video data captured by the physical camera such that the user is within a frame of the virtual camera and (b) a directional set of audio transducers that projects audio in a single direction over a limited portion of the location such that the audio is projected in the direction of the user.

Example 20: The computer-readable-medium of example 19, where the computer-executable instructions further cause the computing device to follow the user with a directional microphone that captures audio input from a specific direction over a portion of the location.

As detailed above, the computing devices and systems described and/or illustrated herein broadly represent any type or form of computing device or system capable of executing computer-readable instructions, such as those contained within the modules described herein. In their most basic configuration, these computing device(s) may each include at least one memory device and at least one physical processor.

In some examples, the term “memory device” generally refers to any type or form of volatile or non-volatile storage device or medium capable of storing data and/or computer-readable instructions. In one example, a memory device may store, load, and/or maintain one or more of the modules described herein. Examples of memory devices include, without limitation, Random Access Memory (RAM), Read Only Memory (ROM), flash memory, Hard Disk Drives (HDDs), Solid-State Drives (SSDs), optical disk drives, caches, variations or combinations of one or more of the same, or any other suitable storage memory.

In some examples, the term “physical processor” generally refers to any type or form of hardware-implemented processing unit capable of interpreting and/or executing computer-readable instructions. In one example, a physical processor may access and/or modify one or more modules stored in the above-described memory device. Examples of physical processors include, without limitation, microprocessors, microcontrollers, Central Processing Units (CPUs), Field-Programmable Gate Arrays (FPGAs) that implement softcore processors, Application-Specific Integrated Circuits (ASICs), portions of one or more of the same, variations or combinations of one or more of the same, or any other suitable physical processor.

Although illustrated as separate elements, the modules described and/or illustrated herein may represent portions of a single module or application. In addition, in certain embodiments one or more of these modules may represent one or more software applications or programs that, when executed by a computing device, may cause the computing device to perform one or more tasks. For example, one or more of the modules described and/or illustrated herein may represent modules stored and configured to run on one or more of the computing devices or systems described and/or illustrated herein. One or more of these modules may also represent all or portions of one or more special-purpose computers configured to perform one or more tasks.

In addition, one or more of the modules described herein may transform data, physical devices, and/or representations of physical devices from one form to another. For example, one or more of the modules recited herein may receive image data to be transformed, transform the image data into a data structure that stores user characteristic data, output a result of the transformation to select a customized interactive ice breaker widget relevant to the user, use the result of the transformation to present the widget to the user, and store the result of the transformation to create a record of the presented widget. Additionally or alternatively, one or more of the modules recited herein may transform a processor, volatile memory, non-volatile memory, and/or any other portion of a physical computing device from one form to another by executing on the computing device, storing data on the computing device, and/or otherwise interacting with the computing device.

In some embodiments, the term “computer-readable medium” generally refers to any form of device, carrier, or medium capable of storing or carrying computer-readable instructions. Examples of computer-readable media include, without limitation, transmission-type media, such as carrier waves, and non-transitory-type media, such as magnetic-storage media (e.g., hard disk drives, tape drives, and floppy disks), optical-storage media (e.g., Compact Disks (CDs), Digital Video Disks (DVDs), and BLU-RAY disks), electronic-storage media (e.g., solid-state drives and flash media), and other distribution systems.

The process parameters and sequence of the steps described and/or illustrated herein are given by way of example only and can be varied as desired. For example, while the steps illustrated and/or described herein may be shown or discussed in a particular order, these steps do not necessarily need to be performed in the order illustrated or discussed. The various exemplary methods described and/or illustrated herein may also omit one or more of the steps described or illustrated herein or include additional steps in addition to those disclosed.

The preceding description has been provided to enable others skilled in the art to best utilize various aspects of the exemplary embodiments disclosed herein. This exemplary description is not intended to be exhaustive or to be limited to any precise form disclosed. Many modifications and variations are possible without departing from the spirit and scope of the instant disclosure. The embodiments disclosed herein should be considered in all respects illustrative and not restrictive. Reference should be made to the appended claims and their equivalents in determining the scope of the instant disclosure.

Unless otherwise noted, the terms “connected to” and “coupled to” (and their derivatives), as used in the specification and claims, are to be construed as permitting both direct and indirect (i.e., via other elements or components) connection. In addition, the terms “a” or “an,” as used in the specification and claims, are to be construed as meaning “at least one of.” Finally, for ease of use, the terms “including” and “having” (and their derivatives), as used in the specification and claims, are interchangeable with and have the same meaning as the word “comprising.”

What is claimed is:

1. A videoconferencing device comprising:
at least one directional sensor that detects a direction of a user relative to the videoconferencing device;
a physical camera that records video data of a location;
a virtual camera that records a subset of the video data such that a camera frame of the virtual camera follows the user as the user moves within the location;
a directional set of audio transducers that projects audio in a single direction over a limited portion of the location; and
a computing module that configures the directional set of audio transducers to project the audio in the direction of the user.

2. The videoconferencing device of claim 1, wherein the computing module configures the directional set of audio transducers by triggering a physical motor to move at least a portion of the directional set of audio transducers.

3. The videoconferencing device of claim 1, wherein the computing module configures the directional set of audio transducers by altering audio data sent to the directional set of audio transducers.

4. The videoconferencing device of claim 1, wherein the computing module configures the directional set of audio transducers by toggling an active state of a portion of the directional set of audio transducers.

5. The videoconferencing device of claim 1:
further comprising a directional microphone that captures audio input from a specific direction over a portion of the location; and
wherein the computing module configures the directional microphone to capture the audio input from the direction of the user.

6. The videoconferencing device of claim 1, wherein the directional sensor comprises at least one of:
a microphone that captures audio of the user; or
the physical camera.

7. The videoconferencing device of claim 1, wherein the directional sensor comprises a device worn by the user that sends location data to the videoconferencing device.

8. The videoconferencing device of claim 1, wherein the directional sensor comprises a set of pressure sensors distributed throughout the location.

9. The videoconferencing device of claim 1, wherein the directional sensor comprises an infrared sensor.

10. The videoconferencing device of claim 1, wherein the computing module:
calculates a distance between the user and the directional set of audio transducers; and
modifies a volume of the audio produced by the directional set of audio transducers based on the distance between the user and the directional set of audio transducers.

11. A computer-implemented method comprising:
identifying a user within a location participating in a videoconference facilitated by a videoconferencing device;
capturing video data of the location via a physical camera;
detecting a direction of the user relative to the videoconferencing device; and
following the user as the user moves around the location during the videoconference via both:
a virtual camera that captures a subset of the video data captured by the physical camera such that the user is within a frame of the virtual camera; and
a directional set of audio transducers that projects audio in a single direction over a limited portion of the location such that the audio is projected in the direction of the user.

12. The computer-implemented method of claim 11, wherein following the user via the directional set of audio transducers comprises triggering a physical motor to move at least a portion of the directional set of audio transducers.

13. The computer-implemented method of claim 11, wherein following the user via the directional set of audio transducers comprises altering audio data sent to the directional set of audio transducers.

14. The computer-implemented method of claim 11, wherein following the user via the directional set of audio transducers comprises toggling an active state of a portion of the directional set of audio transducers.

15. The computer-implemented method of claim 11, further comprising following the user with a directional microphone that captures audio input from a specific direction over a portion of the location.

16. The computer-implemented method of claim 11, wherein detecting the direction of the user relative to the videoconferencing device comprises detecting the direction via at least one of:
a microphone that captures audio of the user; or
the physical camera.

17. The computer-implemented method of claim 11, wherein detecting the direction of the user relative to the videoconferencing device comprises detecting the direction via at least one of:
a device worn by the user that sends location data to the videoconferencing device;
a set of pressure sensors distributed throughout the location; or
an infrared sensor.

18. The computer-implemented method of claim 11, further comprising:
calculating a distance between the user and the directional set of audio transducers; and
modifying a volume of the audio produced by the directional set of audio transducers based on the distance between the user and the directional set of audio transducers.

19. A non-transitory computer-readable medium comprising one or more computer-executable instructions that, when executed by at least one processor of a computing device, cause the computing device to:
identify a user within a location participating in a videoconference facilitated by a videoconferencing device;
capture video data of the location via a physical camera;
detect a direction of the user relative to the videoconferencing device; and
follow the user as the user moves around the location during the videoconference via both:
a virtual camera that captures a subset of the video data captured by the physical camera such that the user is within a frame of the virtual camera; and
a directional set of audio transducers that projects audio in a single direction over a limited portion of the location such that the audio is projected in the direction of the user.

20. The non-transitory computer-readable-medium of claim 19, wherein the computer-executable instructions further cause the computing device to follow the user with a directional microphone that captures audio input from a specific direction over a portion of the location.
